(19) United States
(12) Patent Application Publication
(10) Pub. No.: US 2016/0378930 A1
(43) Pub. Date: Dec. 29, 2016

(54) System and method for generating simulated prescription-drug claims

(71) Applicant: Truveris, Inc., New York, NY (US)

(72) Inventors: Anthony J. Loiacono, Bayonne, NJ (US); Bertrand Janin, West Orange, NJ (US)

(21) Appl. No.: 14/545,857

(22) Filed: Jun. 29, 2015

(51) Int. Cl. G06F 19/00

(52) U.S. Cl. CPC G06F 19/328

(57) ABSTRACT

A computer system and method for generating simulated drug claims, suitable modeling and constructing drug benefit plans, the method, characterized by defining a number of lives covered and total spend amount for the simulated drug claims, wherein the method searches a drug claim database containing a plurality of de-identified, drug claims to retrieve drug claims, based on the number of lives, calculates tiers and tier ratios, determines top dispensed drugs, and creates and populates a set of simulated drug claims, until the spend amount is exhausted.

### BENEFIT OF EARLIER FILED APPLICATION

This application seeks the benefit of U.S. Provisional Application Ser. No. 61/998,430, filed Jun. 28, 2014.

### TECHNICAL FIELD

Generally, the present invention, relates to a computer-implemented system and method for generating simulated drug claims. The system and method utilizes the number of lives to be covered, spend amount for the simulated drug claims, and period of time to search a plurality of drug claims for equivalent claims, which are utilized to generate simulated, prescription-drug claims. The simulated drug claims may be useful determining drug claims of prescription drug benefit plans.

### BACKGROUND OF THE INVENTION

When a plan sponsor (e.g., employer, labor union, insurer, etc.) desires to purchase a prescription, drug benefit plan for its members and their dependents, it may contact a pharmacy benefit manager (“PBM”) or health insurance company, sometimes through a broker or consultant, to negotiate and consummate a contract for the plan. PBMs aggregate the buying power of plan members, enabling plan sponsors to negotiate lower prices for prescription drugs through discounts from retail- and mail-order-pharmacies and rebates from pharmaceutical manufacturers. Prescriptions for plan members are filled and dispensed by retail- and/or mail-order-pharmacies associated with the plan. For each prescription dispensed, an invoice is generated by a PBM or insurer and sent to a plan sponsor in the form of a prescription drug claim. Generally, PBMs will compile and send multiple drug claims to plan sponsors on a monthly basis for payment in accordance with contract provisions.

Generally, to obtain quotes for a prescription drug, benefit plan a plan sponsor may be required to provide at least a previous year's adjudicated drug claims to a PBM before commencing the process. These claims data may be required to determine plan cost as well as understand ‘spends and trends’ (e.g., rate of dispensation of different drugs for a population and amounts of monies spent for dispensed drugs, etc.) for the lives to be covered by the plan. The formal bidding process for these plans may require a plan sponsor to, perhaps, retain a consultant familiar with the PBM industry to negotiate contract terms and pricing on its behalf. The process of obtaining benefit plan quotes entails gathering and reviewing recent years of historical, drug claims data and associated costs to determine current and future costs associated with underwriting a prescription drug benefit plan.

### SUMMARY OF THE INVENTION

The present invention relates to computer systems and methods for generating simulated, prescription drug claims. The systems and methods may utilize information, characterized as a number of lives and a spend amount to generate simulated, drug claims. The simulated, drug claims may be suitable for obtaining drug benefit plan quotes for new plans without previous quotes and negotiating terms relating to benefit plan contracts. The simulated drug claims may also find utility in modeling ‘spends and trends’ relative to drug benefit plans, as well as other analyses that will become apparent to those of ordinary skill in the art upon review of the disclosure hereof.

The present invention is directed to a computer-implemented method for instantaneously (i.e., relative to the time required for compiling drug claims for an actual, drug benefit plan) generating simulated drug claims, suitable for receiving drug benefit plan quotes, and analyzing ‘spends and trends’ relating to drug claims, drug benefit plans and drug dispensations, characterized by:
a) providing a number of lives and spend amount to be simulated by the drug claims to said computer;
b) said computer searching a plurality of drug claims, and retrieving a subset of drug claims, approximate to the number of lives provided, wherein the claims contain information selected from drug type, days' supply, total amount of drug dispensed, claim cost, date of dispensation of drugs, and number of lives covered by a drug benefit plan, and drug tier selected from retail dispense, mail-order-dispense, brand-name drug, generic drug, specialty drug, and time period;
c) said computer determining tiers and tier ratios for the subset of drug claims, wherein the tiers are selected from retail dispense, brand-name drug; retail dispense, generic drug; mail-order-dispense, brand-name drug; mail-order-dispense, generic drug; specialty drug, and wherein the tier ratios are selected from retail dispense, brand-name drugs to retail dispense, generic drugs; mail-order-dispense, brand-name drugs to mail-order-dispense, generic drugs; and dispense, specialty drugs, based on total drugs of the subset;
d) said computer determining top dispensed drugs;
e) said computer generating a set of simulated drug claims, based on determinations of tiers and tier ratios; and
f) said computer populating the set of simulated drug claims, by continuously selecting drug claims from the subset of drug claims, based on the top dispensed drugs, and subtracting the claim price from the spent amount, until the spend amount is negligible.

Generally, tiers and tier ratios may be based on costs of drugs and amounts of drugs dispensed. Selection of top dispensed drugs may be based on information gathered from a drug claims database, or a subset of drug claims selected based on a number of lives to be covered. The simulated drug claims may be useful in negotiating drug benefit plans, analyses of costs and dispensation of prescription drugs, analyses of drug benefit plan spends and trends, as well as other uses that will become apparent to those of ordinary skill in the art. Optionally, prices for the drug claims may be determined in many different ways (e.g., current market prices, average wholesale prices, average drug claim prices, etc.) and should not be viewed as a limitation of the invention. While the actual cost of the drug claim may be used, it may be substituted by prices of the top dispensed drug of a database, where the prices are constantly updated, or other basis may be used. In one embodiment of the invention, prices may be determined for top dispensed drugs by utilizing a drug claims database, average price/unit of drug dispensed, as determined by an NDC identifier.

### BRIEF DESCRIPTION OF THE DRAWING FIGURES

The disclosure of the invention may be readily achieved by considering the following detailed description in conjunction with drawings, wherein:

FIG. 1 is a block diagram illustrating a computer-implemented method of generating simulated drug claims in accordance with an embodiment of the invention;

FIG. 2 is a block diagram illustrating a computer system for performing a method in accordance with an embodiment of the invention;

FIG. 3 is a block diagram illustrating a computer system and method in accordance with another embodiment of the invention; and

FIG. 4 is a block diagram illustrating yet another computer system and method in accordance with the yet another embodiment of the invention.

### DETAILED DESCRIPTION OF THE INVENTION

The present invention is fully described hereinafter with reference to the drawings, in which different embodiments of the invention are illustrated. The invention may be embodied in many different manners, but these embodiments should not be construed as limiting the scope thereof. While these embodiments are included to convey and teach one of ordinary skill in the art the complete scope of the invention, other embodiments will become apparent on reviewing the disclosure.

One of ordinary skill in the art will appreciate that the present invention may be embodied as a computer-implemented method, data processing system, or computer program product of the method disclosed herein. As such, the invention may take the form of an embodiment characterized entirely of hardware; an embodiment characterized entirely of software; or an embodiment characterized as a combination of hardware and software. Additionally, the invention may take the form of a computer-implemented product on a computer-readable storage medium having computer-readable program code means embodied in the medium. Any suitable computer readable medium may be utilized, including hard disks, CD-ROM, optic storage devices, or magnetic storage devices. It should be understood that terms such as “receiving”, “determining”, “calculating”, “searching”, “creating”, “producing”, “analyzing”, “generating”, and the like, refer to actions and processes of a computer system, or similar electronic analytical device that manipulates and transforms data representing physical or electronic quantities within computer system storage, display, and data transmission means and devices.

The present invention is described with reference to drawings and diagrams that illustrate, computer systems and methods hereof. It should be understood that each block of the drawings, and combination of blocks in the drawings, can be implemented by computer program instructions. Such computer program instructions can be loaded onto a general purpose computer, special purpose computer, or other programmable data processing device to produce a machine, that create functions for means specified in the blocks of the drawings.

The method of the present invention may provide instantaneous prescription drug claims, and may be used for providing drug benefit plan quotes to plan sponsors with little to no historical, drug claims data. The term “instantaneous” is defined as the provision of generating simulated drug claims useful for receiving drug benefit plan quotes relative to submission of a bid request, within a shorter period of time, as compared to the large number of days required for receipt of a quote utilizing conventional processes.

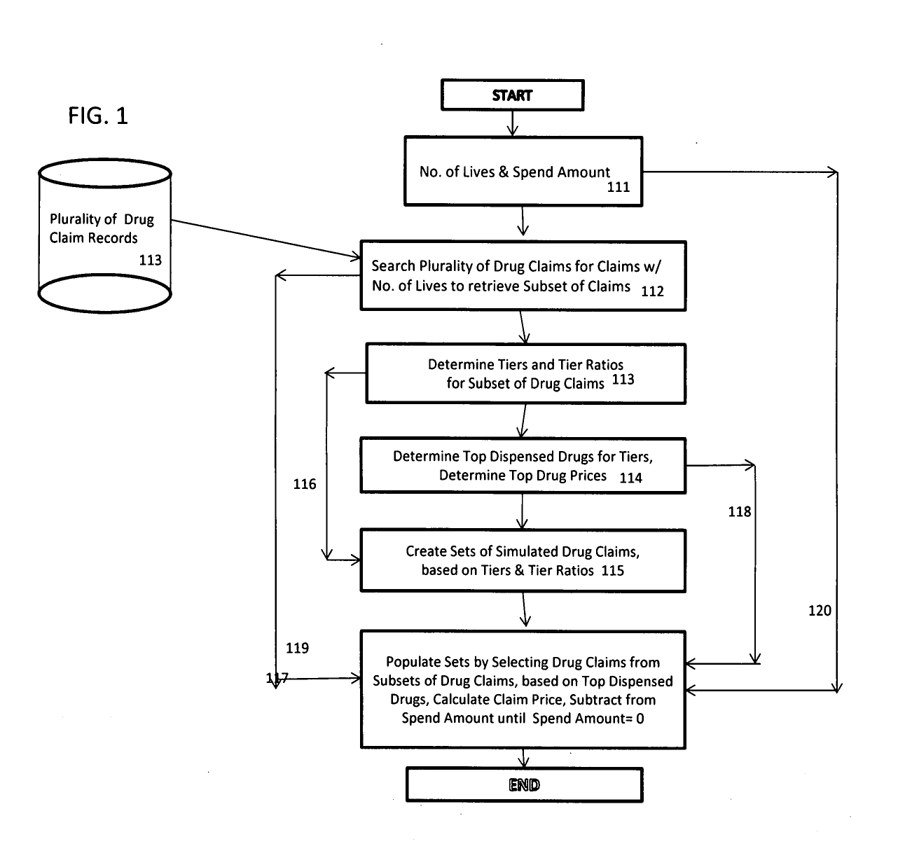

In accordance with FIG. 1, there is illustrated, for an embodiment of the invention, a computer-implemented method for generating simulated drug claims, wherein the method may be characterized by inputting into the computer-implemented method a number of lives and spend amount to be covered by the simulated drug claims (111). The method searches a plurality of drug claim records, based on the number of lives and retrieves a subset of a plurality of drug claims, therefor (112). Next, the method determines tiers and tier ratios for the subset of drug claims, wherein the tiers may be selected from retail dispense, brand-name drugs; retail dispense, generic drugs; mail-order-dispense, brand-name drugs; mail-order-dispense, generic drugs; specialty drugs, and total dispenses, wherein the tier ratios may be selected from: i) retail dispense, brand-name drugs to retail dispense, generic drugs, ii) mail-order-dispense, brand-name drugs to mail-order, dispense generic drugs, and iii) dispense of specialty drugs to total dispense of drugs (113). Since each drug claim of the subset provides tier information, the claims may be sorted according to tier information and the tiers may be characterized in accordance with tier ratios thereof. The method may determine top dispensed drugs for each tier by analyzing the drug claims of each tier for the greatest amount of dispensed drugs (e.g., popularly dispensed drugs), or the selection of top dispensed drugs may be performed by analyzing national- or geographical-data (114) from a drug database or network. In a sequential step, a set of simulated drug claims, based on the tiers and tier ratios, may be generated (115) by the method of the invention. That is, the set of simulated dug claims will be representative of the quantity and quality of drug claims of the tiers and the tier ratios of the subset of drug claims, e.g., the set of simulated drug claims may be generated as a mirror image of the subset of drug claims, e.g., a simulated drug claims of equivalent or similar number of lives may exhibit characteristics of actual size drug plans, wherein greater similarities may be characterized by established parameters for geographical characteristics. Finally, the system populates the set of simulated drug claims, by selecting drug claims from the tiers of the subset of drug claims, based on a descending order of top dispensed drugs, optionally, calculating a new drug claim price (114), and subtracting the new claim price from the spend amount provided for the simulated claims, until the spend amount is exhausted or negligible (111). The steps of populating the set of simulated drug claim, optionally, calculating a new claim price, and subtracting the new claim price from the spend amount continues until all tiers of the set of simulated drug claims are filled with drug claim from the subset, based on the tiers and tier ratios of the subset, or until the spend amount is exhausted or negligible. The set of simulated drug claims generated by the method hereof may be downloaded or printed for additional analyses, uses, and studies.

In another embodiment of the invention, there is disclosed a computer system and method for generating simulated drug claims, wherein the system comprises data input means, data output means, data processing means, data storage means, drug claims database means, and data transmission means amongst data input means, data output means, data processing means, data storage means, and drug claims database means, the method characterized by:
a) inputting simulated drug claims data, comprising number of lives to be covered by the simulated drug claims and spend amount of the simulated claims into the computer system at input means;
b) searching drug claims database means, comprising a plurality of drug claims, wherein each claim of the database provides a number of lives covered by a drug benefit plan, at data processing means, to provide drug claims equivalent to the number of lives to produce a subset of drug claims, wherein each drug claim provides information selected from drug type, days' supply, total amount of drug dispensed, claim cost, and date of dispensation of drugs, wherein the drug claims provide tier information selected from the group consisting of retail dispense; mail-order dispense; brand-name drug; generic drug; and specialty drug; and storing the subset of drug claims at data storage means;
c) determining tiers and tier ratios for the subset of drug claims, utilizing data processing means, wherein the tier ratios are selected from the group consisting of cost of retail-dispense, brand-name drugs to cost of retail-dispense, generic-drugs; cost of mail-order-dispense, brand-name drugs to cost of mail-order-dispense, generic-drugs; and cost of dispense, specialty drugs to cost of dispense, total drugs, and storing the tiers and tier ratios at data storage means;
d) producing top dispensed drugs for the tiers, utilizing data processing means, and storing the top dispensed drugs at data storage means;
e) optionally, determining drug prices for top dispensed drugs, utilizing data processing means, and storing the top dispense drug prices at data storage means;
f) creating a set of simulated drug claims having tiers and tier ratios, based on the tiers and tier ratios of the subset of drug claims, utilizing data processing mean, and storing the set of simulated drug claims at data storage means;
g) populating a tier of the set of the simulated drug claims corresponding to a tier of the subset of drug claims, utilizing data processing means, by randomly selecting a drug claim from a tier of the subset of drug claims according to tiers and tier ratios, based on descending order of dispensation of a top dispensed drug of a corresponding tier of the subset of drug claims, optionally, determining a claim price from the drug price of top dispensed drug and total amount of drugs dispensed for the claim, and subtracting the claim price from the spend amount;
h) continuing to populate the set of simulated drug claims, comprising selecting drug claims from the subset, determining a claim price, and subtracting the claim price from the spend amount, until the spend amount is exhausted, or the set of simulate drug claims is completely populated with drug claims to generate simulated drug claims; and
i) outputting the simulated, drug claims from the computer system, utilizing output means.

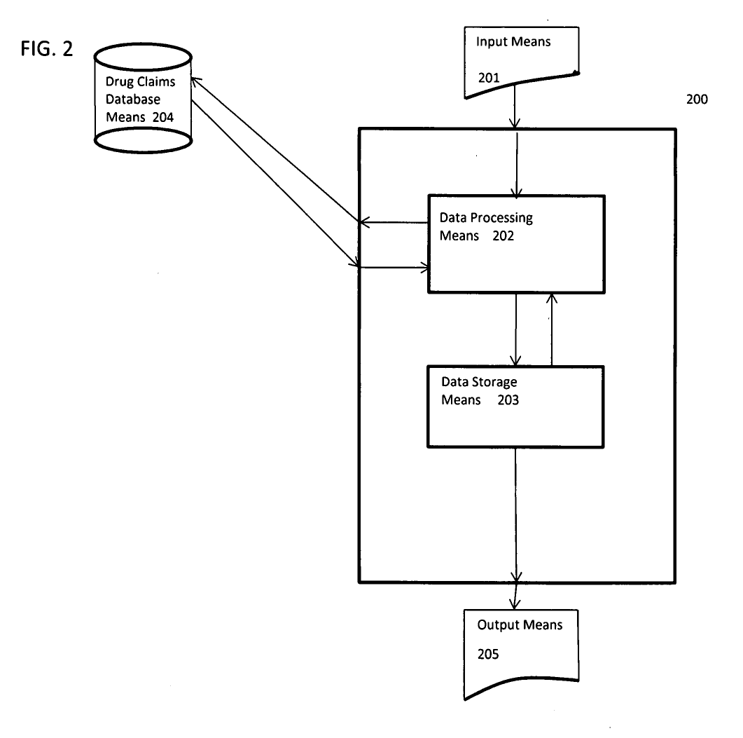

In accordance with FIG. 2, there is illustrated, a computer system for performing the aforementioned method of the invention. The components of computer system (200) may be characterized by input means (201), output means (205), data processing means (DPU) (202), data storage means (203), drug claims database means (204), and data transmission means between the component means. At data input means, information, characterized as a number of lives to be covered by the simulated claims and spend amount (i.e. dollars) for the simulated drug claims may be fed into the computer system at input means. The number of lives to be covered by the simulated drug claims, generally, may be from about 100 to about 50,000 lives, based on drug benefit plan size, wherein a corresponding spend amount may range from about $100,000 to about $200,000,000. Typically, the number of lives to be covered by the simulated drug claims may be from about 1,500 to about 40,000, wherein a corresponding spend amount of the simulated drug claims may range from about $100,000 to about $200,000,000. However, the number of lives to be covered may be based on a limitation of the number of lives covered by a plurality of drug claims within the drug database of drug claims wherein drug claim records are retrieved. Preferably, for drug benefit plans of from about 2,000 lives to about 30,000 lives the spend amount may range from about $250,000 to about $50,000,000.

Various input and output means (201 and 205) may be in communication, via data transmission means, data processing unit (202) and data memory/storage means (203) of the present invention. Such input and output means, generally known to those of ordinary skill in the art, may be selected from keyboards, touch screens, modems, cameras, monitors, printers, etc. Data processing means (202), typically, may include components (e.g., integrated circuits, microprocessor, etc.) to carryout instructions of the method of the invention, including mathematic and logic functions. Typical data storage means (e.g., computer-readable storage medium) (203) may include, but are not limited to, tape drives, hard disk drives, compact disk drivers, etc. The drug claims database means (204), typically, may be any source of previously adjudicated, drug claims, where drug claims may have been previously de-identified in accordance with HIPAA Regulations.

The subset of drug claims, equivalent to the number of lives or a range thereof, may be retrieved from drug claims database means and stored at data storage means. Each drug claim of the subset of drug claims may contain claim information selected from drug identifier (e.g. national drug code (NDC) identifier or equivalent), date of dispensation of the drugs, days' supply (i.e., length of time the dispensed drug will last (e.g., 30-, 60-, 90-days, etc.) until the next refill, assuming patient administers prescribed, daily dosage), total amount of drug dosages dispensed for the drug claim, the cost of the drug claim, and drug tier information selected from the point-of-dispensation of the claim (i.e. retail dispense, or mail-order-dispense), and whether the drug dispensed is a brand-name-, generic-, or specialty-drug.

The drug claims database of the invention, in addition to connectivity to components of the computer system, may be connected to the Internet or other suitable networks for receiving and compiling large amounts of adjudicated, de-identified drug claims from plan sponsors, PBMs, and on-line health information networks (e.g., RxHub, Medimedia, etc.) on a continuous, real time basis. Additionally, the database may be connected to data process means in a manner suitable for sending and receiving data between data process means, data memory/storage unit, drug claims database, and input/output device of the computer system. The drug database means may use the data process to receive drug claim data from the network, the system may be characterized an independent data process means for receiving, sorting and compiling subsets of drug claim data into segments, determining tiers and tier ratios, as well as other functions necessary to provide functions required at the database to organize and respond to commands of data processor means of the system. Data process means may be suitable for receiving and transmitting data signals to and from input/output means, data storage means, and drug claims database means. HIPAA, drug claims containing PHI may be de-identified by removal of certain personal information therefrom (e.g., a patient's —name, —address, —social security number, —street address, etc.). After de-identification, drug claims data may be transmitted amongst computer systems of PBM, insurers, plan sponsors, consultants, and health information networks to permit analyses of trends and spend thereof.

Based on the subset of drug claims compiled according to the number of lives to be covered thereby, data processing means may determine tiers and tier ratios for the subset of drug claims Tiers may be defined as a method for classifying drug claims in accordance a combination of dispensation information and drug identifier. The drug claims data received, sorted, compiled and stored by the database of the invention may contain sufficient amounts of information to determine tiers and tier ratios. Tiers may be expressed as a combination of method of dispensing and NDC-identifier selected from retail dispense, brand-name drug; retail dispense, generic-drug; mail-order-dispense, brand-name drug; mail-order-dispense, generic-drug; and all dispenses of specialty drugs. Tier ratios may be defined as total cost of retail dispense, brand-name drugs to total cost of retail dispense, generic-drugs; total cost of mail-order-dispense, brand-name drugs to total cost of mail-order-dispense, generic-drugs; and total cost of all dispenses of specialty drugs to total cost of all dispenses for the drug claims. Therefore, the invention analyzes the subset of drug claims to determine the ‘method of dispensing’ of the claim and a drug identifier (e.g., NDC identifier) to determine a tier for the drug claim. Tier ratios may be determined after determination of the tiers. After tier and tier ratio determinations, the method determines top dispensed drugs (e.g., most dispensed drugs) for each tier at data processing means and stores the information at data storage means. The top dispensed drugs may be representative of dispenses of drugs for particular number or range of lives to be simulated, or on some larger dataset or reliable source, such as national- or geographical-dispenses, or other basis that will become apparent to it one of ordinary skill in the art. Likewise, the top dispensed drug prices may substituted for a claim cost of the database, based on current manufacturer-prices, market prices, average whole price, average prices of like drugs of the database or subset, or prices found at other resources.

Similar to tier and tier ratio bases, the set of top dispensed drug and prices therefor may be based on populations, geographical regions, drug costs, or drug volumes dispensed. Within the scope of the invention, various trends in spend amounts and costs may be analyzed, based on geographical regions, depending on desire and varying different parameters, as will become apparent to those skilled in the art.

However, the system and method described herein may be suitable for generating simulated drug claim datasets for large- and small-benefit plans. It may be suitable for plan sponsors to generate a multiple, subsets of simulated drug claims when desirous of modeling different combinations of the numbers of lives and spend amount of the industry.

In yet another embodiment of the invention, sets of simulated, drug claims may be generated, based on desired time periods and time period intervals. For example, due to seasonal illnesses, it may be advantageous to divide a period of time representing a set of simulated drug claims into intervals to obtain more realistic results and real-life scenarios. For example, during winter months, e.g. November, December, January, and February in the northeastern U.S., drugs for colds, flu, and viral infections may be dispensed at higher rates, relative to other drugs, that other months of the year. Likewise, during the spring months, e.g. March, April, and May, in the same geographical area, allergy medication may be dispensed at rates higher, relative to other drugs. When a time parameter (e.g., 1 year) is divided into 3, 4 or 12 intervals, more realistic ‘spend and trends’ in drug dispensation, in accordance to seasonal trends, may be modeled. However, drugs dispensed for non-seasonal, long-term illnesses may tend not to vary from month-to-month.

When seasonal, drug dispensations, or dispensations as a function of time, an embodiment of the invention may be, characterized by a computer system and method for generating simulated, drug claims datasets, wherein the computer system comprises data input and output means, data processing means, drug claims database means, data storage means, and data transmission means amongst system components, the method comprising:
a) inputting simulated drug claims data, characterized as a number of lives to be covered by the simulated claims or drug benefit plan, spend amount for the simulated claims or drug benefit plan, time period for the simulated drug claims, and time period interval for division of the time period into smaller equal intervals at input means;
b) searching drug claims database means, characterized as a plurality of drug claims for drug claims equivalent to the number of lives of the simulated claims or drug plan data to produce subsets of drug claims, wherein each claim provides a number of lives covered by the simulated claims or drug benefit plan, wherein the number of subsets is equivalent to the time period interval, at data processor means, wherein each drug claim of the subsets of drug claims provide claim data selected from drug type, days' supply, total amount of drug dispensed, claim cost, and date of drug dispensation, wherein each drug claim of the subsets of drug claims provide drug tier information selected from retail dispense, brand-name drug; retail dispense, generic-drug; mail-order-dispense, brand-name drug, mail-order-dispense, generic-drug; and specialty drug, dispense, and storing the subsets at data storage means;
c) calculating tiers and tier ratios for the subsets of drug claims, at data processor means, wherein the tier ratios may be selected from cost of retail, dispense, brand-name drugs to cost of retail dispense, generic-drugs; cost of mail-order-dispense, brand-name drugs to cost of mail-order, dispense, generic-drugs; and cost of total dispense, specialty drugs to cost of total-dispense drugs, and storing the subsets at data storage means;
d) producing a set of top dispensed drugs for each tier of the subsets of drug claims at data processor means, and storing the sets of top dispensed drugs at data storage means;
e) determining drug prices for the top dispensed drugs at data processor means, and storing the drug prices at data storage means;
f) creating simulated drug claim datasets equivalent in tiers and tier ratios to the subsets of drug claims at data processor means, and storing the datasets at data storage means;
g) populating the simulated drug claim datasets at data processor means, comprising randomly selecting drug claims from matching tier of matching subset, based on top dispensed drug of the tier, calculating a new claim price utilizing the drug cost of the claim and drug price of the top dispensed drug, and subtracting the new claim price from the spend amount;
h) continuing to populate the simulated drug claim datasets, comprising randomly selecting drug claims from tiers of the subsets of drug claims to fill tiers of the simulated drug claim datasets, based on the top dispensed drugs for the tiers, calculating a new claim price, and subtracting the new claim price from the spend amount until the spend amount is exhausted, or all tiers of the simulated drug claim dataset are filled with drug claims; and
i) outputting the simulated drug claims datasets from the system at output means.

The range of the number of lives to be covered, generally, may be from about 100 lives to about 50,000 lives. Typically, the range of the number of lives to be covered may be from 1,500 lives to about 40,000 lives; and preferably, from about 2,000 lives to about 30,000 lives. The range of the spend amount, generally, may be from about $100,000 to about $200,000,000. Typically, the range of the spend amount may be from about $200,000 to about $100,000,000, and preferably, from about $250,000 to about $50,000,000.

In another embodiment of the invention, the range of the time period basis for simulating drug claims of the invention, generally, may be from about one (1) year to about three (3) years. Typically, the time period basis for the simulated drug claims may be one (1) year. The time period interval basis for the simulated drug claims, generally, may be selected from integers of one (1), two (2), three (3), four (4), six (6), twelve (12), etc. For example, if a time period basis for generating simulated drug claims is one (1) year, and the time period is determined to be twelve (12). The one (1) year time period may be divided into twelve (12) intervals, or 12 months to account for monthly changes in drug dispensation amongst the benefit plans. Therefore, adjustments in seasonal illnesses may be accounted for when analyzing annual changes in drug dispensation. Likewise, according to a method of the present invention, when the ‘time period’ is one (1) year and the ‘time period interval’ is twelve (12), for the one (1) year period, twelve (12) subsets of drug claims (a subset for each month of the year) may be created in accordance with tiers for that time period interval. Likewise, the top dispensed drugs may be determined in accordance with the tier-created subsets; top dispensed drugs may be determined for each of the tiers of the 12 subsets of drug claims. Selections of a number of top dispensed drugs for the tiers of the several subsets of drug claims may be based on the total drug claims of a particular tier. Generally, from about 1,000 top dispensed drugs to about 3,000 top dispensed drugs may be selected for each tier of a subset. Typically, from about 1,500 to about 2,500 top dispensed drugs may be selected for each tier discussed herein above. Preferably, there are about 2,000 top dispensed drug selected from each subset of drug claims compiled by the system and method of the invention. When selecting drug claims from the subsets of claims to populate the simulated, drug claim datasets, the claims should be selected from a subset and tiers of matching time period intervals, i.e. select retail dispense, generic-drug claims for January set of claims to retail-dispense, generic-drug from retail-dispense, generic-drug claims for January subset of simulated claims. One embodiment of the invention, wherein the time period is 1 year, and the time period interval is 12 (an interval for each month of the time period), there would be about 2,000 top dispensed drugs for each tier of 12 sets of top dispensed drugs (about 2,000 drugs/tier/month).

Still, in another embodiment of the invention, there is described, a computer system and method for generating simulated, drug claims datasets suitable designing and modeling drug benefit plans, wherein the system, comprises data input and output means, data processing means, data storage means, drug claims database means, drug claims database means, and data transmission means amongst component means of the system, the method comprising:
a) inputting claims data, comprising a number of lives to be covered by the simulated claims, spend amount for the simulated claims, time period for the simulated drug claims, and a time period interval into the system, at input means;
b) searching drug claims database means comprising a plurality of drug claims, wherein each claim provides a number of lives covered by the simulated drug claims, for drug claims equivalent to the number of lives and time period to produce subsets of drug claims, at data processing means, wherein the subsets are divided into time period interval, wherein each drug claim of the subsets provide claim data selected from the group consisting of drug type, days' supply, total amount of drug dispensed, claim cost, and date of drug dispensation, wherein each drug claim of the subsets of drug claims provide tier information selected from the group of retail dispense, brand-name drug; retail dispense, generic-drug; mail-order-dispense, brand-name drug, mail-order-dispense, generic-drug; and dispense, specialty drug, and storing the subsets at data storage means;
c) determining tiers and tier ratios for the subsets of drug claims, at data processor means, wherein the tier ratios are selected from the group consisting of cost of retail dispense, brand-name drugs to cost of retail dispense, generic-drugs; cost of mail-order-dispense, brand-name drugs to cost of mail-order-dispense, generic-drugs; and cost of dispense, specialty drugs to cost of total-dispense, drugs, and storing the tier and tier ratios at data storage means;
d) producing top dispensed drugs for each tier of the subsets of drug claims at data processor means, and storing the top dispensed drugs at data storage means;
e) determining drug prices for the top dispensed drugs at data processor means, and storing the drug prices of top dispensed drugs at data storage means;
f) creating simulated drug claim datasets equivalent in tiers and tier ratios to the subsets of drug claims at data processor means, and storing the simulated drug claim datasets at data storage means;
g) populating the simulated drug claim datasets at data processor means, comprising randomly selecting drug claims from a subset of matching tier, based on top dispensed drug for the tier, calculating a new claim cost utilizing the top dispensed drug price and amount of dispense drugs of the claim, and subtracting the new claim cost from the spend amount;
h) continuing to populate the datasets, comprising randomly selecting drug claims from tiers of subsets matching tiers of datasets to fill tiers of the datasets, based on the top dispensed drugs for the tiers, calculating a new claim cost, and subtracting the new claim cost from the spend amount until the spend amount is negligible, or all tiers of the simulated drug claim datasets are filled with drug claims; and
i) outputting the simulated drug claims datasets from the system, at output means.

For example, the time period for generating a simulated drug claims dataset may be 1-, 2-, or 3-year, wherein a general basis will be about 1-year (i.e., annually). The time period intervals are defined as segments that divide the time period into finite equal portions (e.g., integers of 1, 2, 3, 4, 6, 12, etc.) for more definitive analyses.

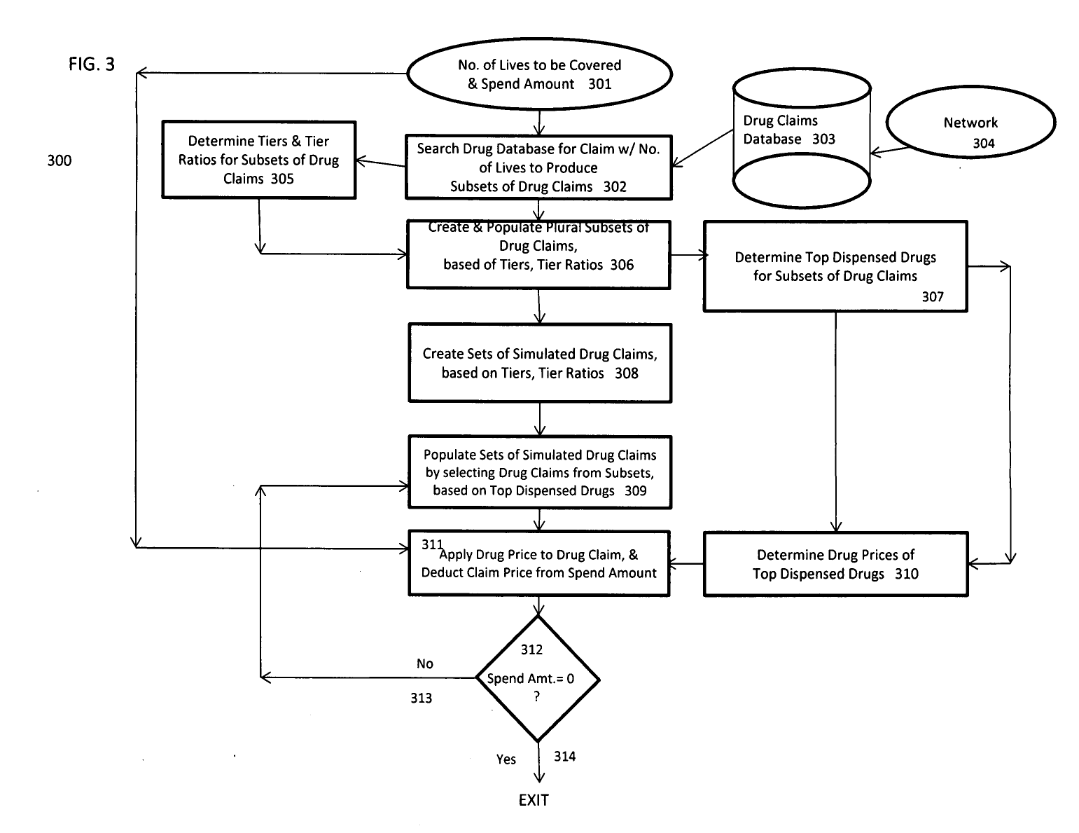

According to FIG. 3, in yet another embodiment of the invention, there is described a method of generating simulated, drug claim datasets that may find a utility in drug benefit plan quotes and ‘spend and trends’ of dispensed drugs, as a function of time, e.g., considering seasonal trends in drug dispensations. On initiating the method, this embodiment of the invention requires input data, characterized as ‘a number of lives’ to be covered by the simulated drug claims, ‘spend amount’ for the simulated drug claims (i.e., dollars, amount that might be paid to a PBM to administer a drug benefit plan), a period of time to be covered by the simulated drug claims (e.g., 1 year), and a time period interval (301). Based on the number of lives and time period, and an equivalent or range of the number of lives to be covered, the method searches (302) a drug claims database (303) of adjudicated, de-identified drug claims (typically, more than about 9-billion drug claims) to retrieve, compile and store drug claims of matching parameter, as a plurality of subsets of drug claims. For instance, if the number of lives to be simulated is about 200, the system and method of the invention may be instructed to search a range of lives of from about 150 to about 300, if desirable. The drug claims database of the invention may in communication with a multitude of other databases and/or networks (304) to receive and store drug claims from various sources (e.g. plan sponsors, PBMs, insurers, clearing houses, etc.). The drug claims of the drug claim database as well as the subset(s) of drug claims retrieved from the database may be de-identified. The drug claims of the database may contain information selected from drug type, days' supply, total amount of drug dispensed, claim cost, and date of dispensation; the claim may also contain dispensing information selected from retail dispense, mail-order-dispense, brand-name drug, generic drug, and specialty drug; and NDC identifier information selected from brand-name drug, generic drug, and specialty drug. This de-identified information associated with the drug claims of database means may be transferred from the database and stored at the computer system for the plurality of subsets of drug claims.

Based on the time period and time period interval, for example a time period basis of the most recent one (1) year and a time period interval of twelve (i.e., 12 months/year), instead of a single subset of drug claims, there may be 12 subsets of drug claims created (e.g., a subset/month/yr.), wherein drug claims from the database having an equivalent (or within the range of) number of lives and dispensation dates within the time period interval (e.g., month of the year) may be complied and stored. Next, for the 12 subsets of drug claims, the method may establish tiers within the subsets (305). That is, depending on the method of dispensation of drugs of a claim (e.g., retail or mail-order) and the drug identifier (e.g., brand-name, generic, or specialty drug), the invention identify a method of dispensation in combination with drug identifier as tiers, wherein the tiers may be selected from retail dispense, brand-name drug; retail dispense, generic drug; mail-order-dispense, brand-name drug; mail-order-dispense, generic drug; or specialty drug (regardless of method of dispense).

Therefore, at each of the 12 subsets there may be stored drug claims at tiers (e.g., retail dispense, brand-name drugs; retail-dispense, generic drug; mail-order-dispense, brand-name drug; mail-order-dispense, generic-drugs; and specialty drugs, based on the total drugs of the subset). Tier ratios may then be determined, based on the number of drug claims, for each tier of the several subsets, wherein the tier ratios may be selected from: i) cost of retail dispense, brand-name drugs to cost of retail dispense, generic-drugs; ii) cost of mail-order-dispense, brand-name drugs to cost of mail-order-dispense, generic-drugs; and iii) cost of total dispense, specialty drugs to cost of total drugs (306). Likewise, the tier ratios may be based on claim cost, or amount of drugs dispensed.

The top dispensed drugs of each of tier of the subsets may be determined by review of the most dispensed drugs (i.e., NDC identifiers) and summing the different drug types, wherein different dosage strength (e.g., concentrations of the same drug) will be represented by different NDCs. However, the top dispensed drugs of a subset may be determined and stored at a data storage component of the system. (307). The top dispensed drugs may be characterized, from top to bottom, as according to a maximum count, based on dispensation of the drugs of a population. Generally, the top dispensed drugs may be based on all drug claims of a large database of drug claims, or a national index of dispensed drug volume.

Thereafter, simulated, drug claim datasets may be created, based on the determination of tier and tier ratios of the subset of drug claims. That is, the tiers and tier ratios of simulated drug claim datasets are equivalent to the tiers and tier ratios of the subsets of drug claims. The sets of simulated drug claims may be generated by data process means and stored at data storage means (308). The purpose of creating simulated drug claims datasets, based on the subsets of drug claims, may serve to follow trends representing a typical drug claim for a typical benefit plan size and time period. Thus, the drug claims of the datasets of simulated drug claim may be designed to resemble drug claim represented by like drug benefit plans or like number of lives to be covered.

Next, the simulated drug claim datasets created (308) may be populated with drug claims from the subsets of drug claims. Based on a top dispensed drug of a like tier from which a subset of simulated drug claims, a drug claim may be randomly selected to populate like tiers of a dataset (309). Random selection of a drug claim from a subset may be performed by methods known to those skilled in the art. In one such method of random selection of drug claims, based on a top dispensed drug, specifications including, a quantity of numbers (e.g., tiers), maximum and minimum values (e.g., listing of top dispensed drugs), and whether a duplicate randomly selected value is permitted (e.g., no, each top dispensed drug may be selected, in order, from highest to lowest, followed by selection of a drug claim from the subset), a fixed number of blank datasets (set of drug claims) may be created, based on a numerical range (top dispensed drugs). In theory, random selection provides a true sampling of a pool, wherein every possible item in the pool has an equal chance of being selected. Random selection software may be added, as a subprogram or main program component to the computer system of the present invention.

Particularly, the random selection of drug claims from a tier of a subset for populating a tier of a dataset may be performed by selecting the top dispensed drug of a tier of a subset, followed by randomly selecting a drug claim of like tier (i.e., drug dispensing method and drug-identifier) and subset (309). For example, a top dispensed drug and drug claim selected from the retail-dispensed, brand-name tier of a subset of January may be used to populate a dataset for the retail-dispense, brand-name tier of January. Thereafter, from a determination of top dispensed drugs, in descending order, a determination of drug prices for top dispensed drugs may be performed (310). The drug price may be taken from any of several sources of drug prices. Drug prices may be selected directly from the drug claims database, network source, or other reliable sources.

Generally, price of a drug (i.e., claim cost divided by amount of drug dispensed) may be applied to the simulate drug claim datasets, or claim cost derived from the database may be used to determine a new price for a drug claim (311). Thereafter, the new price may be applied to the claim. Other methods of determining current drug claim prices may be applied to the present invention, as will become apparent to those of ordinary skill in the art. Once the drug claim price has been assigned to a drug claim, that price may be deducted from the spend amount (301), where simulated drug claim datasets are filled with drug claims from the subsets until the spend amount is exhausted, or all the tiers of the sets are filled with drug claims (312), wherein the system and method are ended, and simulated drug claim datasets are generated by way of an output means.

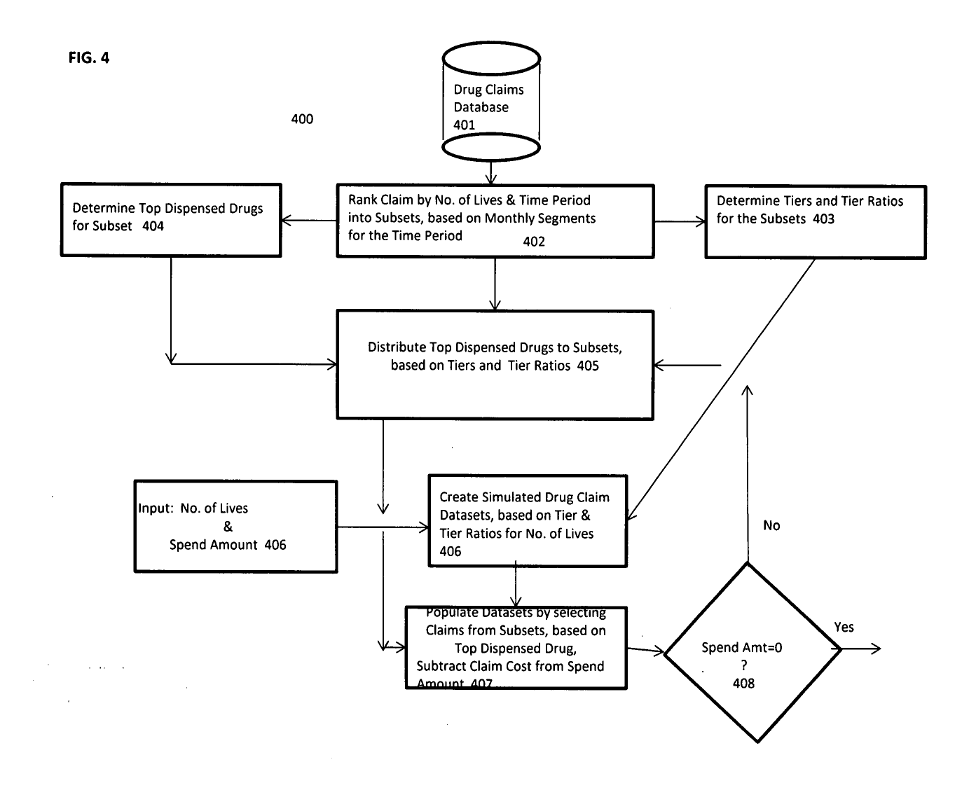

In still another embodiment of a method of the invention, the plurality of drug claims (e.g., ≧about 9-billion drug claims) in the drug claims data base may be analyzed on a real-time bases to compile, sort and store batches of drug claims, based on a number of lives (e.g., intervals of 100 lives, etc.), defined time periods, and defined time period interval. In accordance with FIG. 4, method (400) performed on a computer system, comprises a drug claims database (401) characterized as receiving and storing a plurality of adjudicated, de-identified drug claims for various drug benefit plans. On a continuous, real-time basis, drug claims received by the database may be ranked at a database processor means into segments of about 100 lives covered by a plan (e.g., from 1 to about 100 lives, from about 101 lives to about 200 lives, from about 201 lives to about 300 lives, etc.) and successive months of a year (e.g., 12 time period intervals for any 1-year of drug claim data) into subsets (402), wherein a 1-year-time-period may be represent as 12 subsets of drug claims. Thereafter, the subsets may be analyzed to determine tiers and tier ratios for the time period intervals (403), and the drug claims of the tiers may be ranked in accordance with top dispensed drugs (404) for each tier. In some instances, it may be suitable to determine at least about 2,000 top drugs per tier, based on a database containing at least about 5-billion drug claims. A top dispensed drug for a tier may be matched, based on a count of dispensed drug claims containing the drug (405) with the tier from which the top dispensed drug was selected. Independently, data processor means may be in communication with database processor means to receive database, drug claims, based on a defined number of lives to be covered and spend amount. The method may create a plurality of simulated drug claim datasets (406), based on tiers and tier ratios. That is, from the subsets compiled from the drug claim database, tiers and tier ratios are created, wherein those tier and tier ratios are used to generate like tiers for the simulated drug claim datasets in accordance with the tier ratios. Based on a top dispensed drug for a tier, a drug claim from a like tier of like subset may be selected to fill a like tier of simulated drug claim datasets (407), and the claim cost may be deducted from the spend amount, until the spend amount is exhausted or negligible, wherein simulated drug claim datasets may be created (408).

In yet another embodiment of the invention there is described, a computer system and method for generating simulated, drug claim datasets, wherein the computer system, comprises data input and output means, data processing means, drug claims database means comprising a plurality of drug claims, and data transmission means amongst system components, the method comprising:
a) continuously receiving prescription drug claim data at database means from network drug claim data sources;
b) continuously ranking and sorting drug claims of database means into a plurality of increasing segments of about 100 lives per segment per month per year, based on the number of lives cover by a drug benefit plan, at data processing means, to produce subsets of drug claims, wherein each drug claim of the subsets provide claim data selected from drug type, days' supply, total amount of drug dispensed, claim cost, date of drug dispensation, and number of lives covered by the drug benefit plan, wherein each drug claim of the subsets of drug claims provide tier information selected from retail dispense, brand-name drug; retail dispense, generic-drug; mail-order-dispense, brand-name drug, mail-order-dispense, generic-drug; and dispense, specialty drug, and storing the subsets at data storage means;
c) determining tiers and tier ratios for the subsets, at data processor means, wherein the tier ratios are selected from the group consisting of cost of retail dispense, brand-name drugs to cost of retail dispense, generic-drugs; cost of mail-order-dispense, brand-name drugs to cost of mail-order-dispense, generic-drugs; and cost of dispense, specialty drugs to cost of total-dispense, drugs, wherein the tier ratios are selected from the group consisting of cost of retail dispense, brand-name drugs to cost of retail dispense, generic-drugs; cost of mail-order-dispense, brand-name drugs to cost of mail-order-dispense, generic-drugs; and cost of dispense, specialty drugs to cost of total-dispense, drugs, and storing the tier and tier ratios at data storage means;
d) determining top dispensed drugs from database for the plurality of increasing segments of about 100 lives per segment per month per year, based on the number of lives cover by a drug benefit plan, at data processing means, and storing the top dispensed drugs at data storage means;
e) inputting simulated drug claim data, comprising a number of lives to be covered, spend amount, and time period for the simulated drug claims, at input means;
f) retrieving subsets of drug claims from data storage means, relative to input data of the number of lives covered and time period;
g) retrieving tier and tier ratios from data storage means, relative to input data of the number of lives covered and time period;
h) retrieving top dispensed drugs from data storage means;
i) creating simulated drug claim datasets equivalent in tiers and tier ratios to the subsets of drug claims at data processor means, and storing the simulated drug claim datasets at data storage means;
j) populating the simulated drug claim datasets at data processor means, comprising randomly selecting drug claims from a tier of matching subset, based on top dispensed drug, and subtracting the claim cost from the spend amount;
k) continuing to populate the datasets, comprising randomly selecting drug claims from tiers of subsets matching tiers of datasets to fill tiers of the datasets, based on the top dispensed drugs, and subtracting the claim cost from the spend amount, until the spend amount is negligible, or all tiers of the simulated drug claim datasets are filled with drug claims; and
l) outputting the simulated drug claims datasets from the system, at output means.

What is claimed is:

1. A computer-implemented method for instantaneously generating simulated drug claims, the method comprising:
a) providing a number of lives and spend amount for the simulated drug claims to said computer;
b) said computer searching a plurality of drug claims and retrieving a subset of drug claims, based on the number of lives, wherein the drug claims contain information selected from the group consisting of drug identifier, days' supply, total amount of drug dispensed, claim cost, date of dispensation of drugs, and number of lives covered by a benefit plan, wherein the drug claims contain drug tier selected from the group consisting of retail dispense, mail-order-dispense, brand-name drug, generic drug, and specialty drug;
c) said computer determining tiers and tier ratios for the subset of drug claims, wherein the tiers are selected from the group consisting of retail dispense, brand-name drug; retail dispense, generic drug; mail-order-dispense, brand-name drug; mail-order-dispense, generic drug; and specialty drug, wherein the tier ratios are selected from the group consisting of retail dispense, brand-name drugs to retail dispense, generic drugs; mail-order-dispense, brand-name drugs to mail-order-dispense, generic drugs; and dispense, specialty drugs, based on total drugs of the subset;
d) said computer determining top dispensed drugs;
e) said computer generating a set of simulated drug claims, based on tiers and tier ratios; and
f) said computer populating the set of simulated drug claims, comprising selecting drug claims from tiers of the subset of drug claims, based on the top dispensed drugs and subtracting the drug claim price from the spent amount until the spend amount is negligible.

2. The computer-implemented method of claim 1, wherein the plurality of drug claims is a drug claims database.

3. The computer-implemented method of claim 2, wherein the basis for determining tier and tier ratios is drug costs.

4. The computer-implemented method of claim 3, wherein prices are determined for top dispensed drugs, prices of top dispensed drugs are substituted for claim costs in the sets of simulated drug claims.

5. A computer system and method for generating simulated drug claims, wherein the computer system comprises data input means, data output means, data processing means, data storage means, drug claims database means, and data transmission means amongst data input means, data output means, data processing means, data storage means, and drug claims database means, the method comprising:
a) inputting claims data, comprising number of lives to be covered and spend amount of the simulated claims into the computer system at input means;
b) searching the drug claims database means comprising a plurality of drug claims, at data processing means, to provide drug claims equivalent to the number of lives and spend amount to produce a subset of drug claims, wherein the drug claims provide information selected from the group consisting of drug type, days' supply, total amount of drug dispensed, claim cost, date of dispensation of drugs, and number of lives covered by the simulated claims, wherein the drug claims provide tier information selected from the group consisting of retail dispense; mail-order-dispense; brand-name drug; generic drug; and specialty drug; and storing the subset of drug claims at data storage means;
c) determining tiers and tier ratios for the subset of drug claims, utilizing data processing means, wherein the tier ratios are selected from the group consisting of cost of retail dispense, brand-name drugs to cost of retail dispense, generic-drugs; cost of mail-order-dispense, brand-name drugs to cost of mail-order-dispense, generic-drugs; and cost of specialty drugs to cost of total dispense drugs, and storing the tiers and tier ratios at data storage means;
d) producing top dispensed drugs for the tiers, utilizing data processing means, and storing the top dispensed drugs at data storage means;
e) optionally, determining drug prices for top dispensed drugs, utilizing data processing means, and storing the drug prices at data storage means;
f) creating a set of simulated drug claims having tiers and tier ratios, based on the tiers and tier ratios of the subset of drug claims, utilizing data processing mean, and storing the set of simulated drug claims at data storage means;
g) populating a tier of the set of the simulated drug claims corresponding to a tier of the subset of drug claims, utilizing data processing means, by randomly selecting a drug claim from a tier of the subset of drug claims according to tier ratios, based on descending order of dispensation of a top dispensed drug of a corresponding tier of the subset of drug claims, optionally, determining a claim price from said drug price of top dispensed drug and total amount of drugs dispensed for the claim, and subtracting the claim price from the spend amount;
h) continuing to populate the tiers of set of simulated drug claims, optionally, determining a new claim prices, and subtracting the claim prices from the spend amount, until the spend amount is exhausted, or the set of simulate drug claims is completely populated with drug claims to generate the set of simulated drug claims; and
i) outputting the simulated, drug claims from the computer system, utilizing output means.

6. The method of claim 5, wherein the number of lives is from about 100 lives to about 50,000 lives.

7. The method of claim 6, wherein the spend amount is from about $100,000 to about $200,000,000.

8. The method of claim 7, wherein the top dispensed drugs are selected from drug database means.

9. The method of claim 8, wherein the top dispensed drugs provide updated drug claims.

10. The method of claim 9, wherein tier and tier ratio bases are selected from the group consisting of drug cost and drug dispensation.

11. The method of claim 10, wherein tier and tier ratios are based on drug cost.

12. The method of claim 11, wherein output means is selected from a printer and data transfer module.

13. The method of claim 12, wherein the simulated drug claims provide information selected from the group consisting of drug type, days' supply, total amount of drug dispensed, claim price, and date of dispensation of drugs, and drug tier selected from the group consisting of retail dispense, mail-order-dispense, brand-name drug, generic drug, and specialty drug.

14. A computer system and method for generating simulated, drug claim datasets, wherein the computer system, comprises data input and output means, data processing means, drug claims database means, data storage means, and data transmission means amongst system components, the method comprising:
a) inputting data, comprising a number of lives to be covered by the simulated claims, spend amount for the simulated claims, time period for the simulated drug claims, and a time period interval into the system, at input means;
b) searching drug claims database means comprising a plurality of drug claims for drug claims equivalent to the number of lives and time period to produce subsets of drug claims, at data processing means, wherein the subsets are divided into time period interval, wherein each drug claim of the subsets provide claim data selected from the group consisting of drug type, days' supply, total amount of drug dispensed, claim cost, date of drug dispensation, and number of lives covered by the simulated claims, wherein each drug claim of the subsets of drug claims provide tier information selected from the group of retail dispense, brand-name drug; retail dispense, generic-drug; mail-order-dispense, brand-name drug, mail-order-dispense, generic-drug; and dispense, specialty drug, and storing the subsets at data storage means;
c) determining tiers and tier ratios for the subsets of drug claims, at data processor means, wherein the tier ratios are selected from the group consisting of cost of retail dispense, brand-name drugs to cost of retail dispense, generic-drugs; cost of mail-order-dispense, brand-name drugs to cost of mail-order-dispense, generic-drugs; and cost of dispense, specialty drugs to cost of total-dispense, drugs, and storing the tier and tier ratios at data storage means;
d) producing top dispensed drugs for each tier of the subsets of drug claims at data processor means, and storing the top dispensed drugs at data storage means;
e) determining drug prices for the top dispensed drugs at data processor means, and storing the drug prices of top dispensed drugs at data storage means;
f) creating simulated drug claim datasets equivalent in tiers and tier ratios to the subsets of drug claims at data processor means, and storing the simulated drug claim datasets at data storage means;
g) populating the simulated drug claim datasets at data processor means, comprising randomly selecting drug claims from a subset of matching tier, based on top dispensed drug for the tier, calculating a new claim cost utilizing the top dispensed drug price and amount of dispense drugs of the claim, and subtracting the new claim cost from the spend amount;
h) continuing to populate the datasets, comprising randomly selecting drug claims from tiers of subsets matching tiers of datasets to fill tiers of the datasets, based on the top dispensed drugs for the tiers, calculating a new claim cost, and subtracting the new claim cost from the spend amount until the spend amount is negligible, or all tiers of the simulated drug claim datasets are filled with drug claims; and
i) outputting the simulated drug claims datasets from the system, at output means.

15. The computer system and method of claim 14, wherein the number of lives is from about 100 lives to about 50,000 lives.

16. The computer system and method of claim 15, wherein the range of the number of lives is from 1,500 lives to about 40,000 lives.

17. The computer system and method of claim 16, wherein the spend amount is from about $200,000 to about $100,000,000.

18. The computer system and method of claim 17, wherein the time period interval is selected from the group consisting of 1, 2, 3, 4, 6 and 12.

19. The computer system and method of claim 18, wherein the time period is about one (1) year.

20. The computer system and method of claim 19, wherein the sets of top dispensed drugs per tier per time period interval is at least about 2,000 drugs/tier/month.

21. The computer system and method of claim 20, wherein the drug price is the average market-price, based on drug database means.

22. A computer system and method for generating simulated, drug claim datasets, wherein the computer system, comprises data input and output means, data processing means, drug claims database means containing a plurality of drug claims, and data transmission means amongst system components, the method comprising:
a) continuously receiving prescription drug claims data at database means from network drug claims data sources;
b) continuously ranking and sorting drug claims of database means into a plurality of increasing segments of about 100 lives per segment per month per year, based on the number of lives covered by a drug benefit plan at data processing means to produce subsets of drug claims, wherein each drug claim of the subsets provide claim data selected from the group consisting of drug type, days' supply, total amount of drug dispensed, claim cost, date of drug dispensation, and number of lives covered by a drug benefit plan, wherein each drug claim of the subsets of drug claims provide tier information selected from the group of retail dispense, brand-name drug; retail dispense, generic-drug; mail-order-dispense, brand-name drug, mail-order-dispense, generic-drug; and dispense, specialty drug, and storing the subsets at data storage means;
c) determining tiers and tier ratios for the subsets, at data processor means, wherein the tier ratios are selected from the group consisting of cost of retail dispense, brand-name drugs to cost of retail dispense, generic-drugs; cost of mail-order-dispense, brand-name drugs to cost of mail-order-dispense, generic-drugs; and cost of dispense, specialty drugs to cost of total-dispense, drugs, wherein the tier ratios are selected from the group consisting of cost of retail dispense, brand-name drugs to cost of retail dispense, generic-drugs; cost of mail-order-dispense, brand-name drugs to cost of mail-order-dispense, generic-drugs; and cost of dispense, specialty drugs to cost of total-dispense, drugs, and storing the tier and tier ratios at data storage means;
d) determining top dispensed drugs from database for the plurality of increasing segments of about 100 lives per segment per month per year, based on the number of lives cover by a drug benefit plan, at data processing means, and storing the top dispensed drugs at data storage means;
e) inputting simulated drug claim data, comprising a number of lives to be covered, spend amount for the simulated claims, and time period for the simulated drug claims, at input means;
f) retrieving subsets of drug claims from data storage means, relative to input data of the number of lives covered and time period;
g) retrieving tier and tier ratios from data storage means, relative to input data of the number of lives covered and time period;
h) retrieving top dispensed drugs from data storage means;
i) creating simulated drug claim datasets equivalent in tiers and tier ratios to the subsets of drug claims at data processor means, and storing the simulated drug claim datasets at data storage means;
j) populating the simulated drug claim datasets at data processor means, comprising randomly selecting drug claims from a tier of matching subset of drug claims, based on top dispensed drug, and subtracting the claim cost from the spend amount;
k) continuing to populate the datasets, comprising randomly selecting drug claims from tiers of subsets matching tiers of datasets to fill tiers of the datasets, based on the top dispensed drugs, and subtracting the claim cost from the spend amount, until the spend amount is negligible, or all tiers of the simulated drug claim datasets are filled with drug claims; and
l) outputting the simulated drug claims datasets from the system, at output means, wherein the simulated drug claims are specific for the number of lives to be covered, spend amount, and time period specified.
